(19) United States
(12) Patent Application Publication
(10) Pub. No.: US 2019/0088978 A1
(43) Pub. Date: Mar. 21, 2019

(54) CONTINUOUS MANUFACTURING OF STACKED ELECTROCHEMICAL DEVICE WITH POLYMER INTERLAYER

(71) Applicant: Dyson Technology Limited, Wiltshire (GB)

(72) Inventors: Marc LANGLOIS, Ann Arbor, MI (US); Chia-Wei WANG, Ypsilanti, MI (US); Ann Marie SASTRY, Ann Arbor, MI (US); HyonCheol KIM, Ann Arbor, MI (US); Myoungdo CHUNG, Ann Arbor, MI (US); Xiangchun ZHANG, Ann Arbor, MI (US); Yen-Hung CHEN, Ann Arbor, MI (US)

(73) Assignee: Dyson Technology Limited, Wiltshire (GB)

(21) Appl. No.: 15/705,423

(22) Filed: Sep. 15, 2017

(51) Int. Cl. H01M 10/04; H01M 2/16; H01M 2/14

(52) U.S. Cl. CPC H01M 10/0436; H01M 2220/30; H01M 2/145; H01M 2/1653

(57) ABSTRACT

A method for the continuous or semi-batch manufacture of a solid-state battery device using a high speed process. The method can include forming multiple repeating stacks of thin film layers overlying a substrate in order to form multiple solid state batteries connected in series or parallel, wherein forming the multiple repeating stacks of thin film layers includes forming a polymer interlayer. The method can also include stacking multiple stacks of thin film layers of multi-layer battery cells connected in parallel or in series.

### FIELD OF THE INVENTION

The present invention relates to techniques for manufacturing solid state electrochemical cells. More particular, the present invention provides a method and system for continuous manufacturing of stacked electrochemical devices with polymer interlayer(s).

### BACKGROUND OF THE INVENTION

There are significant manufacturing challenges in providing solid state thin film batteries in stacked cell configurations. This is evidenced by the fact that to date, only miniature solid state batteries have been commercialized for use, by example, on credit cards or RFID tag.

As applications continue to require greater power and efficiency from batteries, techniques for improving solid-state thin film battery devices are highly desired.

### SUMMARY OF THE INVENTION

This present invention relates to manufacture of thin film electrochemical cells. More particularly, the present invention provides a process and method for manufacturing a solid-state thin film battery device. Merely by way of example, the invention has been described with the use of lithium based cells, but it is recognized that other materials such as zinc, silver, copper, cobalt, iron, manganese, magnesium and nickel could be designed in the same or like fashion. In a first aspect, the present invention provides a method for the continuous or semi-batch manufacture of a solid-state battery device using a high speed process, the method including: forming multiple repeating stacks of thin film layers overlying a substrate in order to form multiple solid state batteries connected in series or parallel, wherein forming the multiple repeating stacks of thin film layers includes forming a polymer interlayer having a thickness of 0.5 μm or less.

The present invention provides a procedure for formation of one or more elements of an electrochemical cell using a complete process. In an embodiment, the present invention provides a process for complete deposition of electrochemical cell materials, including anode, cathode, electrolyte, barriers, stress modifying layers, and embedded current collectors, including combinations thereof.

In an embodiment, a means of stabilizing the surface roughness of lithium metal is disclosed. This roughness occurs, at least in part, from the previously unrecognized or unappreciated motion of lithium atoms when energy is delivered. Typical thin film layers on top of lithium are not conformal, and in most cases increase the surface roughness. By application of a liquid polymer thin film, and by controlling the rheological properties of that liquid, it has been shown to be possible to decrease the surface roughness. Subsequent cross linking of the polymer thin film locks this surface in place allowing for additional layers, in this case, electrochemical cells, to be deposited without the degradation caused by surface roughness replication seen in the present art.

In an embodiment, it is shown that layers less than the surface roughness of 0.5 microns RMS are effective at preventing subsequent layers from increasing exponentially in roughness.

In an embodiment, it is shown that it is not feasible to utilize thick layers between each anode and subsequent layers without increasing the parasitic material to a point where the final battery will not have attributes suitable for marketing or sale. Therefore, in this embodiment, it is the computation of mass and volume increase that dictates the size and number of layers in the device.

In an embodiment, it is shown that it is possible to employ fewer layers than the number of battery stacks and still achieve device improvement.

In an embodiment, it is shown that these layers may be deposited by a number of means, including but not limited to, polymer multilayer (PML), spraying, dipping, slot die coating, roller coating and the like, and that the curing of these liquid monomer layers may be implemented by application of energy (such as electron bombardment, or ultra violet light) by thermal energy, by evaporation, or by chemical cross linking as in two or more component systems.

In an embodiment, it is disclosed that these layers may be applied at vacuum, at atmosphere, in line in a continuous process and in a semi-batch process or in a fully batch process.

By way of example, the surface roughness indicated may contain attributes and portions of all defects found in the product, either produced by process conditions, or contained in the product material itself. It is further understood that the method itself may be a combination of methods and may affect the electrochemical properties of the thin film, and may be the cause of significant improvements in ionic conductivity, electrical resistivity, contact resistance, and the like; all of which are incorporated herein. The thickness of the cathode material may vary through the stack, in that each of the cells deposited onto the substrate may have varying amounts of cathode material. This type of hybridization can allow for the battery device to have varying power output modes during use. The polymer interlayer may be associated with each of the solid state batteries within the stack such that the solid state batteries are of uniform thickness. This can allow for easier handling and production of the stack given that each cell within the stack is made to be a standard size.

Depending upon the specific embodiment, one or more of these benefits may be achieved. Of course, there can be other variations, modifications, and alternatives. The present invention achieves these benefits and others in the context of unique and non-intuitive process technology. However, a further understanding of the nature and advantages of the present invention may be realized by reference to the latter portions of the specification and attached drawings. It is also clear that embodiments of the invention can be optimized or changed for materials and layer thicknesses; however, the intrinsic invention and its purpose are conserved.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1 is a simplified flow diagram of a method for manufacturing an electrochemical cell according to an embodiment of the present invention.

FIG. 2 is a simplified cross-sectional diagram of an electrochemical cell according to an embodiment of the present invention.

FIG. 3 is a simplified cross-sectional diagram of an electrochemical cell having a rough surface according to an embodiment of the present invention.

FIG. 4A is a simplified cross-sectional diagram of an electrochemical cell having an applied smoothing layer according to an embodiment of the present invention.

FIG. 4B is a black and white photograph of the smoothing layer applied over the rough surface of an electrochemical cell, as depicted in FIG. 4A, according to an embodiment of the present invention.

FIG. 5 is a simplified cross-sectional diagram of a stacked electrochemical cell according to an embodiment of the present invention.

FIGS. 6A and 6B are cross-section diagrams of stacked thin film battery devices according to embodiments of the present invention.

FIG. 7 is a table of values related to the manufacturing of solid-state thin film battery devices according to an embodiment of the present invention.

FIG. 8 is a table of values related to the manufacturing of solid-state thin film battery devices according to an embodiment of the present invention.

FIG. 9 is a table of abbreviations used to denote layers of a solid-state thin film battery device according to an embodiment of the present invention.

FIGS. 10A and 10B are simplified cross-sectional diagrams of a solid-state thin film battery device according to embodiments of the present invention.

FIGS. 11A and 11B are simplified cross-sectional diagrams of a solid-state thin film battery device according to embodiments of the present invention.

FIGS. 12A and 12B are simplified cross-sectional diagrams of a solid-state thin film battery device according to embodiments of the present invention.

### DETAILED DESCRIPTION OF THE INVENTION

Lithium ion batteries occupy substantial three-dimensional volumes to be useful. By way of example, those used in the Apple iPhone 4® and the GM Volt® achieve this usefulness by being deposited on a web or flexible substrate and stacked or wound with separator webs and current collector webs to form a size and electrical performance suitable for use. The wound or stacked devices are then terminated by a number of means, all of which use an excess of space and weight to compensate for small area electrical connections due to manufacturing problems associated with termination along the entire length of the current collectors.

As for solid-state technology, those in the field have attempted to build multi-layer, or stacked solid-state batteries, deposited one upon the other, but have been limited to only a single layer of cells due to manufacturing problems. These manufacturing problems include the difficulties of building multiple stacks one upon the other without transmitting defects and systematically increasing the roughness of layers or stress in the layers. Asperity and roughness in previous layers are propagated to subsequent layers, which prevents the manufacturing of a multiple stack structure. Considering that thousands of stacked layers are desired to be competitive in the current market, conventional techniques for thin film battery devices are inadequate.

Another inherent problem is the termination of a large number of opposite polarity, extremely thin current collectors in a minimum space with minimum weight and with the robustness required for commercial applications. Furthermore, the time to manufacture and the capital cost of equipment to deposit thousands of layers is not cost viable. The thin film batteries thus far produced are severely limited in energy and usefulness, and are not readily scalable. Those skilled in the art have been unable to manufacture thin film solid-state batteries useful in replacing conventional technology, particularly those batteries for extended use in consumer electronics or in automobiles.

One of the advantages of thin film solid-state batteries is their ability to be manufactured in precision sufficient to allow large numbers of parallel cells to form higher energy density devices without the detrimental effects often seen in conventional technology. These detrimental effects include: breakdown of the liquid dielectric, growth of films at the anode and cathode interface to the dielectric, dendrite growth of the anode materials, spot heating at particles and shorting.

As noted above, the physics of the conventional state of inorganic materials useful in solid-state batteries overcomes almost all of these detrimental effects except for the very thin layers required to operate at charge and discharge rates that are useful. This, in turn, leads to vast numbers of these very thin cells being connected in parallel. Furthermore, the subsequent manufacturing requirements of terminating this high number of current collectors, whose thicknesses can be in the range of 100 to about 5000 Angstroms, onto terminals that can carry 10's of amps are extremely difficult. These very thin layers play an important role in the superior energy density of solid-state batteries, as the volume and mass they contribute is very minor; however, this same benefit represents a major manufacturing problem due to their delicate nature.

Added to these issues is the need for extreme robustness both physically and electrically, and the not insubstantial requirement to minimize the mass and size of the terminations. The conventional state of the art utilizes shaped current collectors ending in tabs, which contact only a portion of the width of the current collector. This can have serious deleterious effects on the interface impedance between the current collector and the termination. In fact, a substantial number of battery pack failures have been traced to poor terminations.

Another manufacturing problem with solid-state batteries is the glass or ceramic nature of the cathode and electrolyte. These films are thin and brittle having little strength, especially in tension. Submicron sized defects, especially in the electrolyte layer, can cause performance degradation or complete failure. Consequently, handling of these layers of thin films presents great challenges in product quality.

Further, in order to realize the true high energy density potential of solid-state batteries, little volume and mass can be given over to the type of bulky terminations and packaging used in present commercial batteries. What works for conventional wet technology does not make economic sense for solid-state.

When lithium is deposited, it has been found that processing will cause unfavorable changes in its morphology. This unexpected phenomenon is partially caused by the mobility of the metal itself. The addition of energy, in the form of radiation, condensation, or bombardment results in movement of atoms of lithium into adjacent areas. These morphological changes include increased corrosion, surface roughening, and changes in uniformity and trapping of useful lithium in layers that are subsequently not useful for electrochemical activity, thus reducing the energy density of the battery device.

Clearly, this change constitutes a significant obstacle to manufacturing of thin film solid state batteries of any appreciable size. Where this problem has been known and dealt with is in the semiconductor industry, but the key difference is that it is debris that causes the change in surface smoothness and it is controlled by only extreme means of cleanliness in work environments, process vessels, and materials. This method is not applicable to multi-layer solid state batteries.

Secondly, for solid state batteries to be commercially viable, they must represent a substantial improvement in energy density compared to the current state of the art. In most all cases, this required hundreds to thousands of stacked individual electrochemical cells connected in parallel, series or any combination thereof, in one battery device.

The time to manufacture thousands of layers of different material in quantities that would be sufficient to address the mobile communications or transportation markets, would require excessively long manufacturing times using present manufacturing methods. Calculations show that weeks or months would be required to produce a single batch of battery devices.

In situ measurement and quality control alone is not sufficient to allow the high yields of battery devices necessary for profitability with these long manufacturing campaigns. Finally, taken together, the capital cost of a single manufacturing line capable of addressing these markets, is cost prohibitive. To illustrate the need for this invention, and its uniqueness, we will examine the current literature illustrating both lack of understanding of this phenomenon, or its mitigation.

Regarding surface roughening and replication of defects, work has been published that expresses ideas including the manufacturing of thin film solid state batteries built by placing one on top of the other. By way of example, US 2006/0111752 discusses multiple stacked thin film batteries. However, in this invention, the cells are deposited on opposing sides of an aluminum web that is 4 microns thick. Further, there are only two electrochemical cells contemplated in the stack and multiple batteries are shown to be placed side by side to increase their number. This patent also teaches that “advantageously, no insulation layers are required anywhere within the cell stack” contrary to the present invention. Patent Application 2002/0110733 by Johnson describes an electrochemical device of “at least two thin film battery cells”. Other US patents, such as U.S. Pat. No. 7,131,189 by Jenson teach that battery cells may be fabricated on a flexible web, cut out, and then placed side by side, or folded, or wound as in current wet chemistry battery devices. In U.S. Pat. No. 6,994,933 by Bates, there is discussion of an organic layer by PML or other deposition technology that is subsequently cross linked by radiation, however; in all cases, this patent teaches this layer is solely for barrier protection—i.e. to protect a lithium metal anode from atmospheric corrosion. Finally, U.S. Pat. No. 6,706,449 Mikhaylik et al teaches the use of a PML layer to be used as a barrier to protect the battery from degradation originating in a PET or other flexible substrate. Nowhere does this patent teach the use of multiple stacked cells with PML type layers between would be useful.

Referring to U.S. Pat. No. 8,231,998 (deposited solid state battery cells), U.S. Pat. No. 7,945,344, (computationally designed solid state battery cells), U.S. Pat. No. 8,357,464 (deposited solid state battery cells), U.S. Pat. No. 8,301,285 (computationally optimized solid state battery cells) patents, incorporated herein, we teach that the optimum design for energy density consists of electrochemical cells with a number of multiple repeating layers of current collectors, cathodes, anodes and electrolytes with strategically placed interlayers to act as mitigating substrate layers without effecting the economic attributes of the finished device.

An aspect of the present invention involves computationally optimized parasitic planarization layers. As described in detail in Example I, the inclusion of a planarization layer is counter intuitive to a design for optimum energy density. Adding any additional material to a battery device that does not contribute to electrochemical performance will cost money, time, capital, volume and mass. However, according to the present invention, computation can minimize this parasitic component to the point where the structural and manufacturing benefits are retained while still production a commercially viable product.

Finally, as demonstrated by the present invention, it is possible to calculate mathematically, the optimum number of stations in a tool, the number of in situ stacked electrochemical cells and a final battery product of commercial capability while retaining a viable return on investment (ROI). This is detailed extensively in example II and example III.

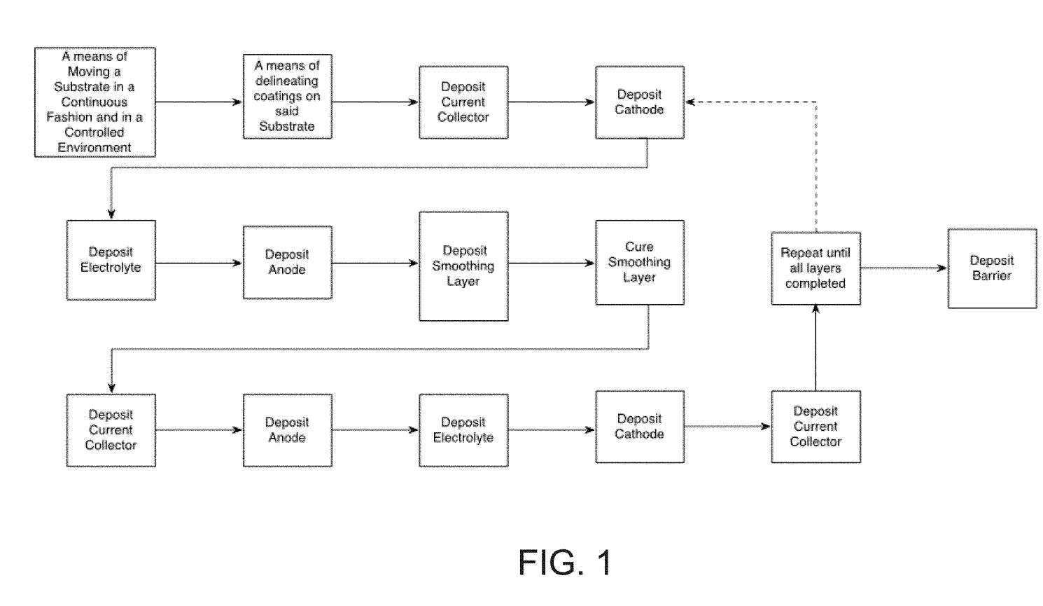

FIG. 1 is a simplified flow diagram of a method for manufacturing an electrochemical cell according to an embodiment of the present invention. As further described and illustrated in FIG. 1, the elemental steps are as follows, and these steps may be repeated in a variety of sequences to produce multilayer stacks. We note that these configurations depend upon the method of isolation of layers in the battery cells.

The steps shown in FIG. 1 are as follows:
1. A means of moving a substrate in a continuous or semi-batch fashion inside of a controlled environment as described in detail in U.S. Pat. No. 8,231,998 and patent applications US 2012/0005830, US 2012/0005280.
2. Deposition of the delineated solid state thin film current collector
3. Deposition of the delineated solid state thin film cathode
4. Deposition of the delineated solid state electrolyte
5. Deposition of the delineated solid state anode
6. Deposition of the delineated smoothing layer according to the present invention
7. Cross linking or curing of the smoothing layer according to the present invention
8. Deposition of the delineated solid state thin film current collector
9. Deposition of the delineated solid state thin film anode
10. Deposition of the delineated solid state thin film electrolyte
11. Deposition of the delineated solid state thin film cathode
12. Deposition of the delineated solid state thin film current collector
13. Repeat (1 through 13) until the desired number of layers have been deposited
14. Deposit barrier layer
15. Other steps as desired

It is further envisioned in the present invention that the order and number of layers may be modified without compromise of the usefulness of the present invention. Those of ordinary skill in the art will recognize other variations, modifications, and alternatives.

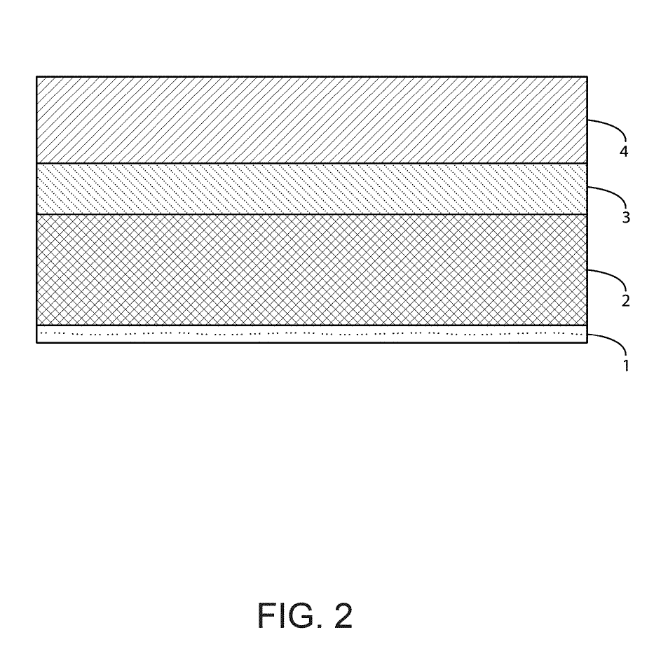

FIG. 2 is a simplified cross-sectional diagram of an electrochemical cell according to an embodiment of the present invention. FIG. 2 describes an idealized thin film solid state battery. The battery as depicted includes a current collector 1, a cathode 2, an electrolyte 3, and an anode 4. In this depiction, and in virtually all depictions of thin film solid state batteries, the layers are completely flat and homogenous. However, this is not the case in production, particularly in the production of multiple stacked solid state thin film batteries.

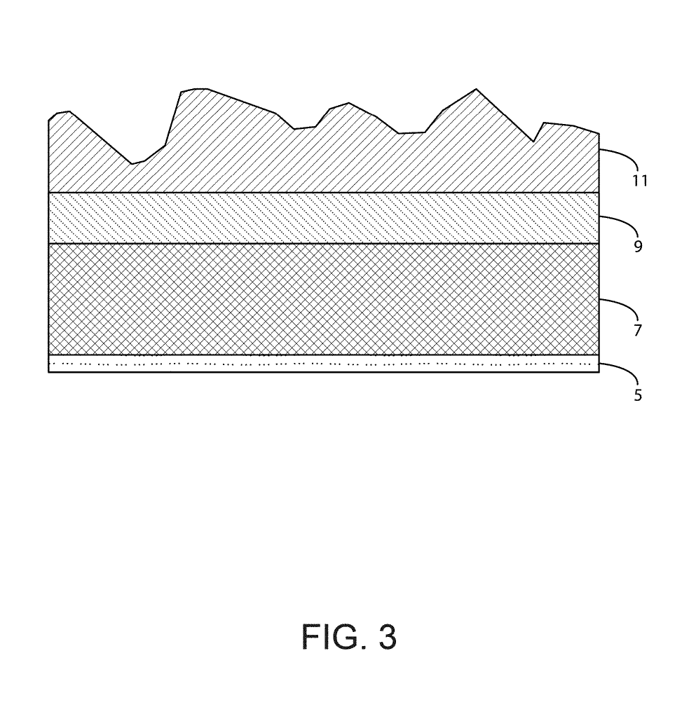

FIG. 3 is a simplified cross-sectional diagram of an electrochemical cell having a rough surface according to an embodiment of the present invention. FIG. 3 describes what more closely resembles what is produced in production or in a laboratory setting. As described earlier, when lithium is used for an anode material, the nature of this material, under most any addition of energy, is to move preferentially, i.e. non-uniformly. This movement results in the rough surface shown in FIG. 3. Here, the device includes a current collector 5, a cathode 7, an electrolyte 9, and a rough layer of lithium metal anode.

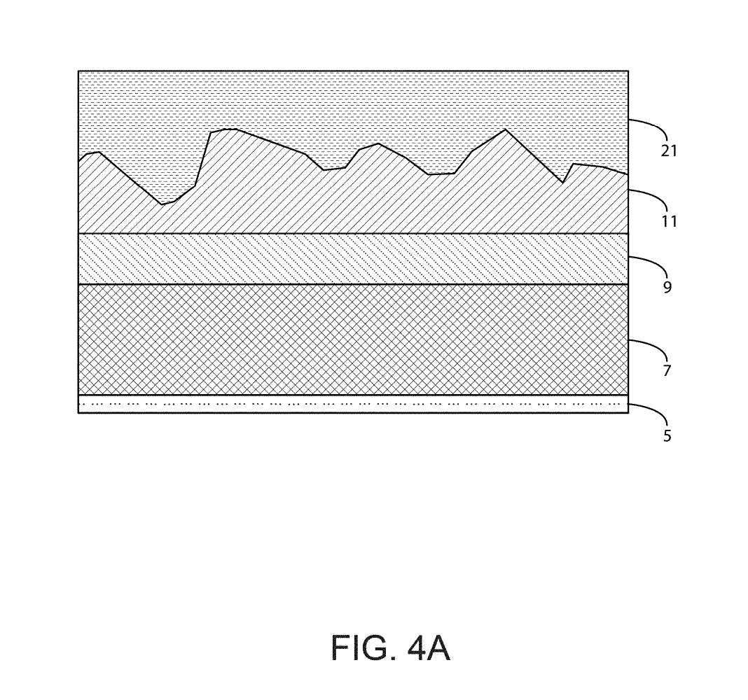

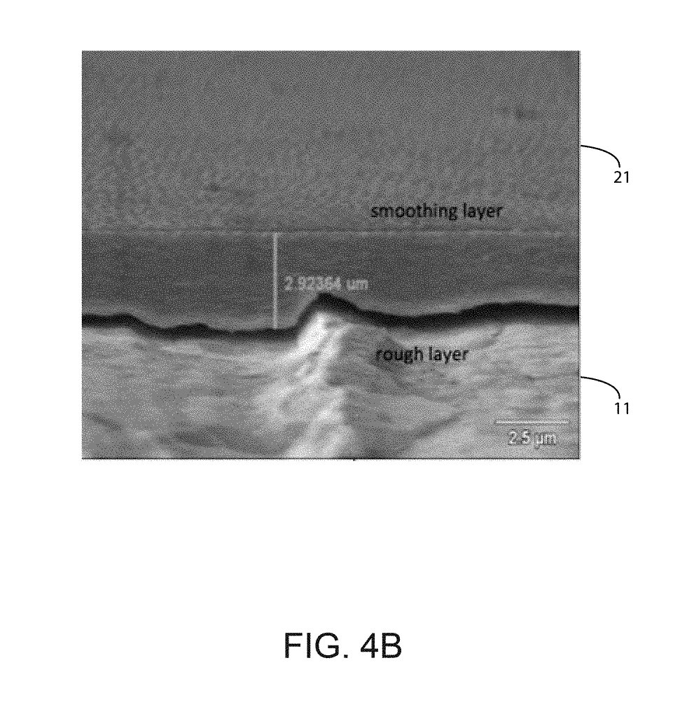

FIG. 4A is a simplified cross-sectional diagram of an electrochemical cell having an applied smoothing layer according to an embodiment of the present invention. FIG. 4 describes the solid state electrochemical cell after an application of the present invention, specifically, the smoothing of the roughened lithium metal anode layer. It is anticipated by the present invention that the smoothing layer 21 can be applied not only to the rough surface of the lithium metal anode 11 (as in FIG. 3), but to any rough layer while keeping within the intent of this invention and its improvements.

FIG. 4B is a black and white photograph of the smoothing layer applied over the rough surface of an electrochemical cell, as depicted in FIG. 4A, according to an embodiment of the present invention. Smoothing layer 21 is shown overlying the rough anode lithium metal layer 11. A reference measurement is shown at a height of 2.92364 um illustrating an example of relative thickness.

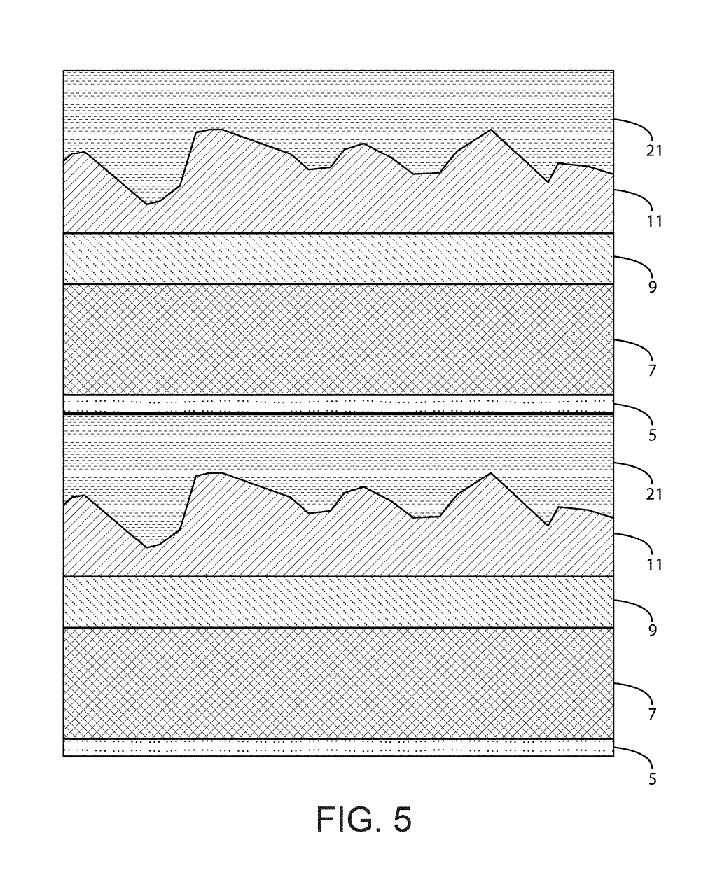

FIG. 5 is a simplified cross-sectional diagram of a stacked electrochemical cell according to an embodiment of the present invention. As shown, FIG. 5 describes a further embodiment of the present invention wherein the addition of the smoothing layer allows the stacking of additional solid state electrochemical cells one on top of the other. This allows a multi-layer stacked configuration of a thin film solid-state battery device. Specifically, this method enables the stacking of cells by mitigating the surface roughness created by deposition conditions, stresses, temperature or energy changes, and diffusion that may occur from high quality manufacturing of commercial value batteries (i.e. having an energy capacity sufficient for personal communications, military applications, transportation, or the like).

In one embodiment, the electrochemically inactive polymeric layer is deadweight for the solid-state electrochemical device in terms of electrical capacity and energy. It is designed specifically to prevent active ions transport to layers that active ions are not supposed to move into. Also, the flexibility of the polymeric layer can also reduce the induced stress on the layers above and below the polymeric interlayer during the manufacturing process of the solid-state electrochemical devices. Therefore, the design of the thickness of this/these electrochemically inactive interlayer(s) becomes important, because the weight or/and volume of this solid-state electrochemical device might be important to certain applications; for example, portable mobile device. In the following example, it clearly demonstrates the fact. The following three examples will describe various embodiments of the present invention.

### Example I

Electrochemical solid-state lithium battery can be used to power the smartphone. The solid-state lithium battery comprises several solid-state lithium cells connected in parallel, series or any combination thereof, or/and in series to have marketable capacity and energy. The traditional polymer lithium ion battery used in 2011 smartphone has the capacity ranging from 1.2 Ah to 2 Ah. The electrochemical solid-state lithium battery is similar to polymer lithium ion battery. Both of them comprises of cathode, anode, electrolyte, current collector, and other packaging materials to provide the electrical power and energy to the smartphone. The cathode and anode are the active materials, which mean that they are the one to provide electrons. However, electrolyte, current collectors and other packaging materials are deadweight to the electrochemical cell, because they only have been used for certain functions, such as insulating electrons to contact anode and cathode, and conducting electrons to the external circuitry. Hence, it is desired to reduce electrolyte, current collector, and packaging materials weights and sizes when design the lithium ion electrochemical cell for smartphone applications.

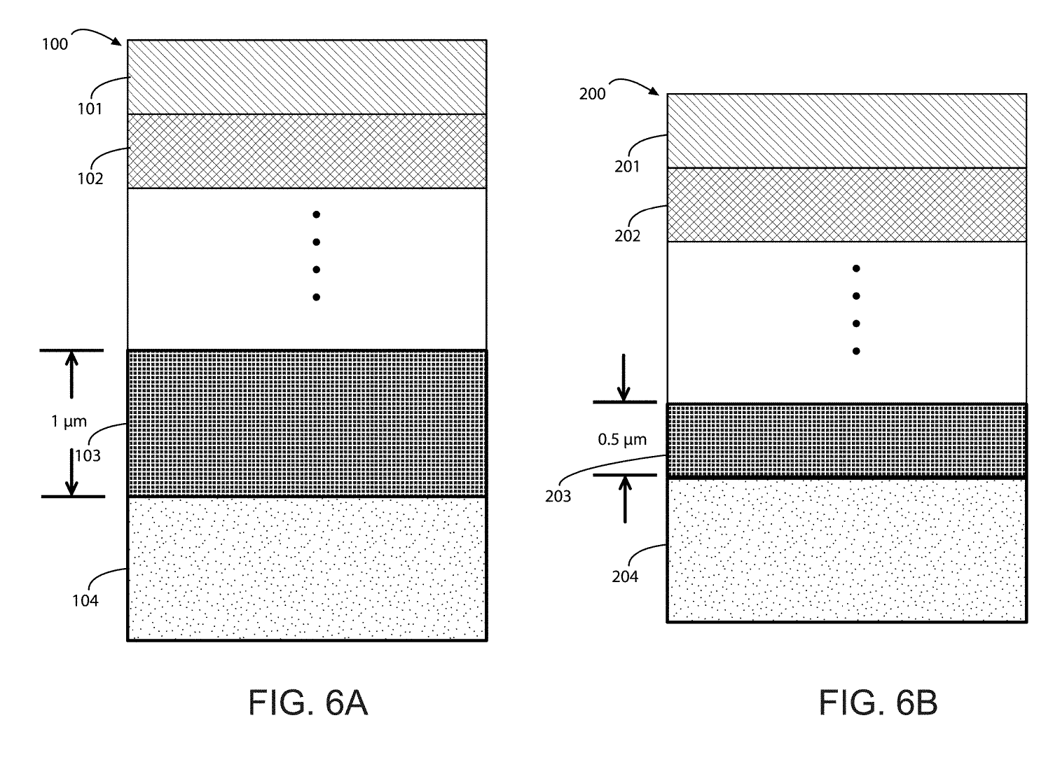

FIGS. 6A and 6B are cross-section diagrams of stacked thin film battery devices according to embodiments of the present invention. In this example, two different designs, A (100 shown in FIG. 6A) and B (200 shown in FIG. 6B) have been used to demonstrate the impact of the size of the electrochemically inactive polymer layers on the volumetric energy density of the solid-state electrochemical lithium battery. In both design, they all comprise the same materials and sizes of cathode, electrolyte (102/202), anode (101/201), current collector, and substrate (104/204), except on the thickness of the electrochemically inactive polymer interlayers labeled in 103 and 203.

The thickness of said layer is 1 μm and 0.5 μm for designs A and B, respectively. Two electrochemical solid-state lithium batteries will be discharged at C/10. The volumetric energy density of design A is 793 Wh/L, but the one of design B is 936 Wh/L. For reference purpose, the volumetric energy density of polymer lithium ion batteries used in smartphone in 2012 was ranging from 400 Wh/L to 650 Wh/L. For design A, it only improves from conventional polymer lithium ion about 20% in terms of volumetric energy density (650 to 793 Wh/L). However, it improves about 45% in terms of volumetric energy density (650 Wh/L to 936 Wh/L). Therefore, the thickness of electrochemical inactive polymeric interlayer should be less than 0.5 μm to be marketable attractive, if the goal is 50% more improvement over market available conventional lithium polymer battery.

In one embodiment, multiple multi-layer thin-film electrochemical cells stacking or wrapping to form single solid-state electrochemical device can increase the production rate for such devices, and decrease its cost for production of one such device. The solid-state electrochemical device, especially energy storage device, is assembled by hundreds or even thousands of solid-state electrochemical energy cells to have significant amount of energy or capacity to be used in commercial electronics or vehicular applications. One layer of solid-state electrochemical cell comprises all the fundamental components so that it can be used for generating an electromotive force (voltage) and current from chemical reactions, or the reverse, inducing a chemical reaction by a flow of current.

Producing multi-layer of thin-film electrochemical cells instead of stacking or wrapping multiple one-layer of electrochemical cells to form a single electrochemical device can increase such device energy density and reduce additive steps cost for stacking or wrapping multiple one-layer of electrochemical cells. However, the default rate for multi-layer thin-film electrochemical cells is associated with the number of layer deposited in one multi-layer thin-film cell. Therefore, it is necessary to design such device carefully in terms of choosing the number of layer in one multi-layer thin-film cell used in this solid-state electrochemical device.

Producing large amount of multi-layers of solid-state electrochemical cell is a challenging task. In order to achieve the economically viable products, it requires increasing the production rate, and production yield. However, these two goals sometimes are against each other. In order to increase the production rate for solid-state electrochemical devices, it requires reducing the time for pumping up and down of vacuum chamber, and the time for loading and unloading substrates and materials, because these steps are not contributing to producing cells but are the prerequisite steps. The method is to increase the number of layer of multi-layer of electrochemical cells to be deposited in one run to reduce the time spending on pumping up and down of vacuum chamber.

On the other hand, to increase the yield is to decrease the number of layers of multilayer thin-film electrochemical cells so that increases the chance of identifying the defect cells and removing it. For example, if the yield rate of producing the one layer of solid-state electrochemical cell is 99%, which means one defect cell will be occurred in 100 one-layer electrochemical cells produced. If one solid-state electrochemical device requires 1000 of such one-layer electrochemical cells, this would mean that the yield rate to produce such device would be 0.

To increase its production yield rate of producing such solid-state electrochemical device needs to be able to screen and discard out the intolerable defect from multi-layer of electrochemical cells before it occurred. It clearly is a trade-off between increasing the production rate and increasing the yield rate. In the following example, they demonstrate the trade-off between these two goals:

### Example II

In this example, the multi-layer or one-layer thin-film solid-state electrochemical cells (301) are deposited on a substrate (302) driven by two rollers (302) inside a vacuum chamber. The sources (304) of the vapor are positioned at the bottom of the web. It assumes that the web can position 4000 cells (301) with proper masks. It also assumes that it requires 2100 layers of one-layer thin-film electrochemical cells to produce single solid-state electrochemical device. The time to assemble the solid-state electrochemical device from the multiple multi-layers of thin-film electrochemical cells is about 1 sec. The assembling process is finished by digital controlled robotic arm. It assumes that the yield to manufacture one-layer electrochemical cell is 99%.

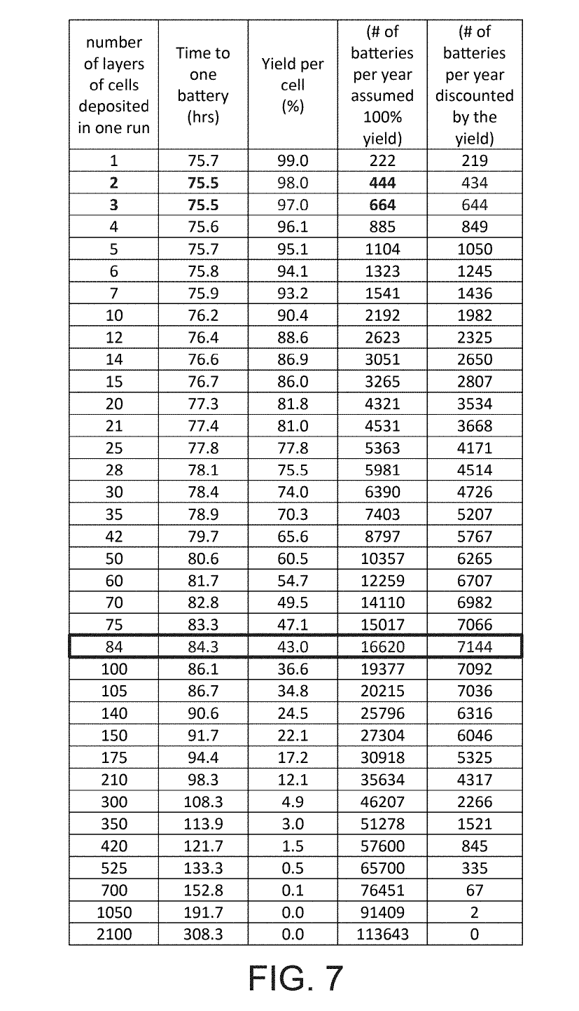

FIG. 7 is a table of values related to the manufacturing of solid-state thin film battery devices according to an embodiment of the present invention. The following table demonstrated that the effect of number of layers of multi-layer thin-film electrochemical cell (301) on the time to finish one battery and on the total number electrochemical devices made in one year. For example, if two layers of multi-layer thin-film electrochemical cell per cell (301) will be deposited on the web, it would take about 75.5 hours to produce single solid-state electrochemical device, which needs about 2100 layers of the basic unit cells; and it would produce 444 such device per year.

Simultaneously, the following table also shows that if we want to minimize the time to make a battery, it only requires 2 layers of one-layer thin-film electrochemical cells per cell on the web. But, it can only output 443 solid-state electrochemical devices per year. On the other hand, if we want to maximize the number of battery to make per year, it would be reasonable to maximize the number of layers of basic unit electrochemical cells. In this case, 2100 layers are the maximum number per cells should be deposited. Therefore, there are about 114,000 solid-state electrochemical devices produced per year. However, it reaches the maximum number of batteries that can be made successfully at 7144 solid-state electrochemical devices per year when the number of layer of multi-layer electrochemical cell is 84 layers after discounted with the yield rate.

In this example, the effect of the number of layers per cell on the time to produce one solid-state electrochemical device is clearly demonstrated and so is the number of such devices can be produced within certain of time.

### Example III

In this example, the same deposition chamber is used as in 300. It assumes that the web also can position 4000 cells (301) with proper masks. It also assumes that it requires 2100 layers of one-layer thin-film electrochemical cells to produce single solid-state electrochemical device. But in this example, the time to assemble the solid-state electrochemical device from the multiple of multi-layer electrochemical cell is about 10 sec. The assembling process is also finished by digital controlled robotic arm. The following table demonstrated that the effect of number of layers of one-layer thin-film electrochemical cell (301) on the time to finish one battery and on the total number electrochemical devices made in one year. For example, if two one-layer thin-film electrochemical cells per cells (301) will be deposited on the web, it would take about 79 hours to produce one solid-state electrochemical device, which needs about 2100 layers of the basic unit cells; and it would produce 434 such device per year.

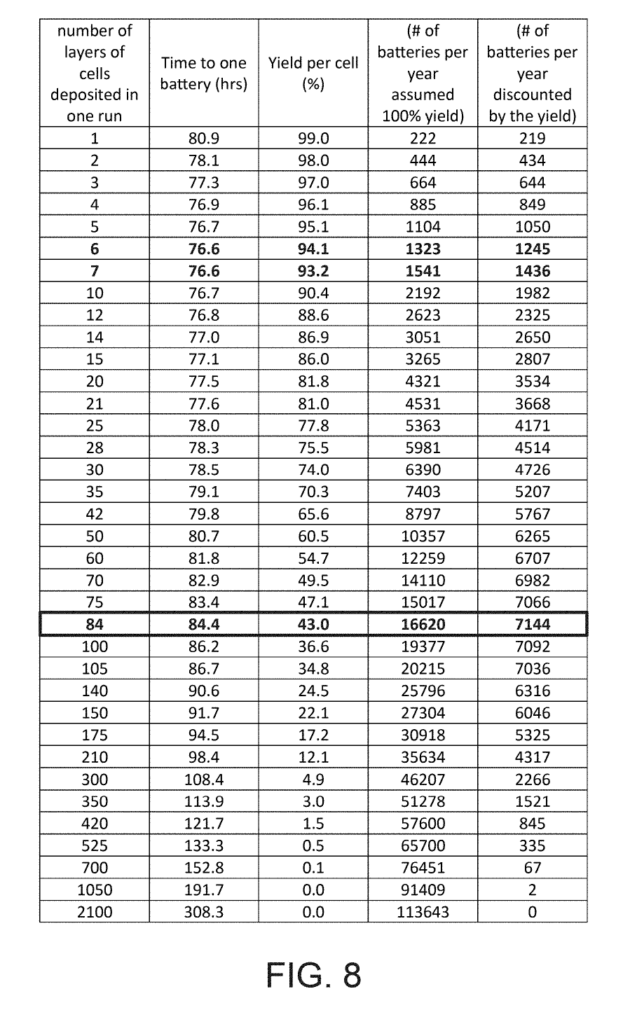

Simultaneously, the following table also shows that if we want to minimize the time to make a battery, it requires 6 layers of one-layer thin-film electrochemical cells per cell on the web. FIG. 8 is a table of values related to the manufacturing of solid-state thin film battery devices according to an embodiment of the present invention. The time to produce one solid-state electrochemical device is about 77 hours. But, it can output 1245 solid-state electrochemical devices per year.

On the other hand, if we want to maximize the number of battery to make per year, it would be reasonable to maximize the number of layers of basic unit electrochemical cells. In this case, 2100 layers are the maximum number per cells should be deposited. Therefore, there are about 114,000 solid-state electrochemical devices produced per year. However, it would take about 309 hours to make one cell. However, it reaches the maximum number of battery can be made successfully at 7144 solid-state electrochemical devices per year when the number of layer of multi-layer electrochemical cell is 84 layers after discounted with the yield rate.

With cases shown in Example II and III, the time to assemble multiple multi-layer thin-film electrochemical cells to solid-state electrochemical device also has impact on the minimum time to produce a battery and the number of layers of cell. However, in these two cases they show that the time to produce a battery and total number of battery produced per year are almost no different when the number of layer per cell is above 42 layers.

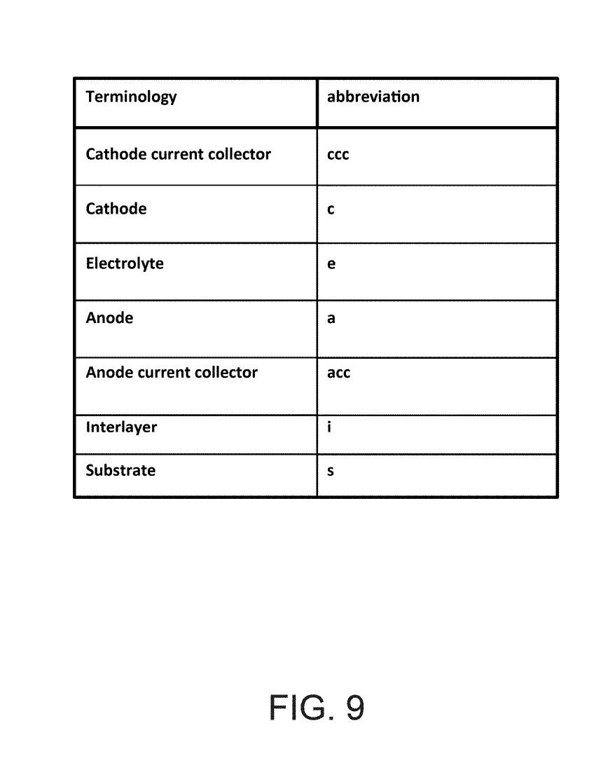

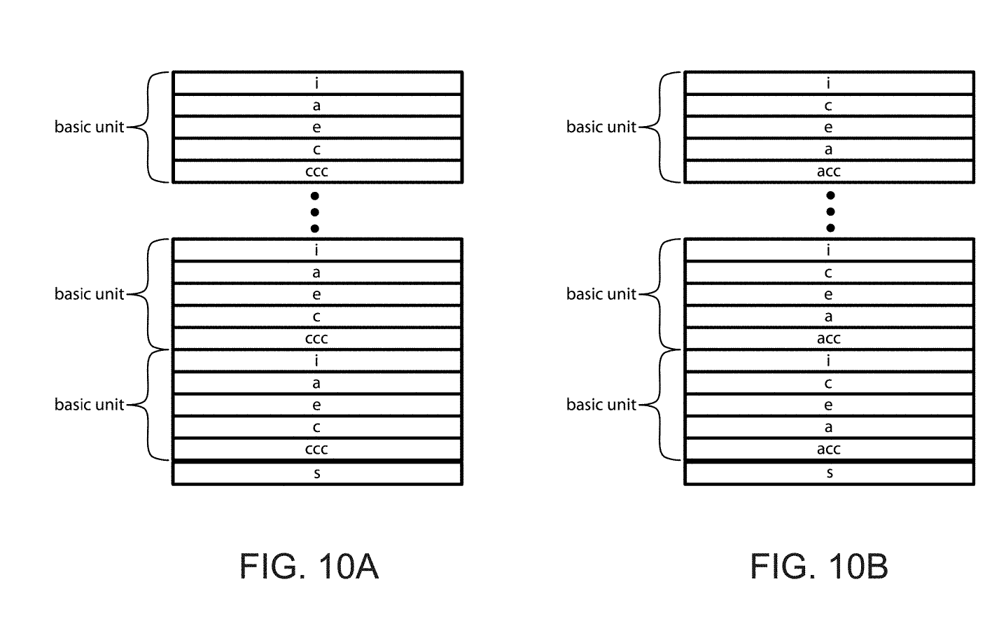

FIG. 9 is a table of abbreviations used to denote layers of a solid-state thin film battery device according to an embodiment of the present invention. As shown, the abbreviations table includes the following: ccc (cathode current collector), c (cathode), e (electrolyte), a (anode), acc (anode current collector), i (interlayer), and s (substrate). According to various embodiments of the present invention, multiple layer configurations are possible using this novel manufacturing approach, with notation shown as FIG. 9, and including but not limited to those shown as FIGS. 10, 11, and 12.

FIGS. 10A and 10B are simplified cross-sectional diagrams of a solid-state thin film battery device according to embodiments of the present invention. As shown, FIG. 10 A illustrates a basic unit of an electrochemical cell including from top to bottom: an interface layer, an anode layer, an electrolyte layer, a cathode layer, and a cathode current collector layer. These basic units are stacked upon a substrate layer. FIG. 10B shows a similar configuration, except that the positions of the anode and cathode layers are swapped compared to FIG. 10A and the cathode current collector is replaced with an anode current collector.

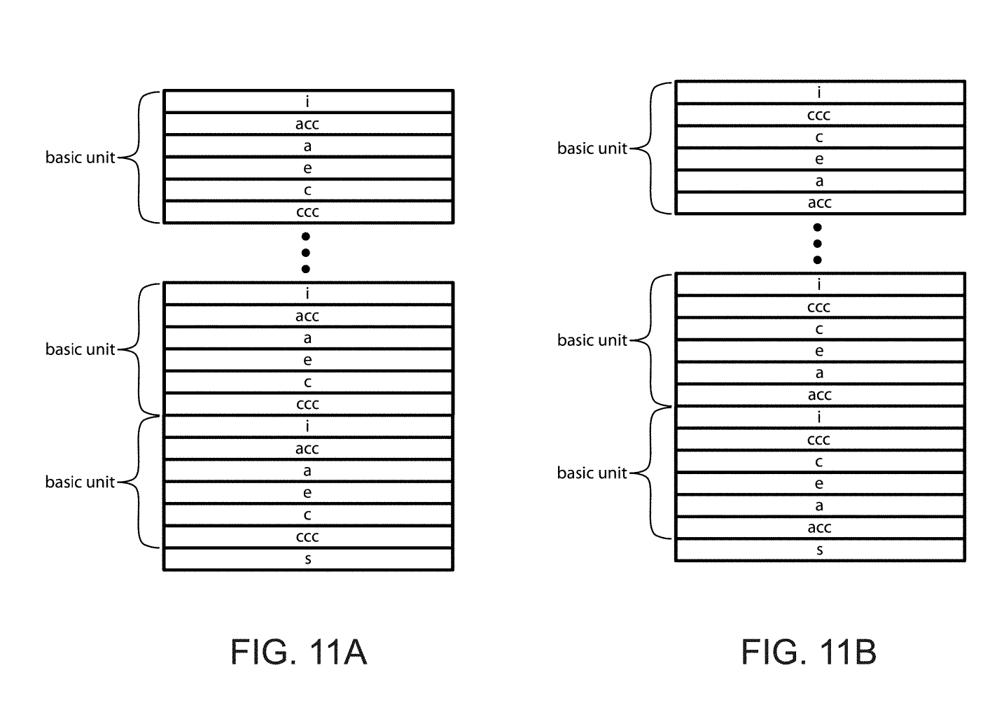

FIGS. 11A and 11B are simplified cross-sectional diagrams of a solid-state thin film battery device according to embodiments of the present invention. As shown, FIG. 11A illustrates a basic unit of an electrochemical cell including from top to bottom (using the abbreviations table): i, acc, a, e, c, and ccc. Just as in FIGS. 10A and 10B, these basic units are stacked upon a substrate layer. Also, FIG. 11B illustrates a similar configuration where the positions of the anode and cathode are swapped and the anode current collector and cathode current collector are swapped.

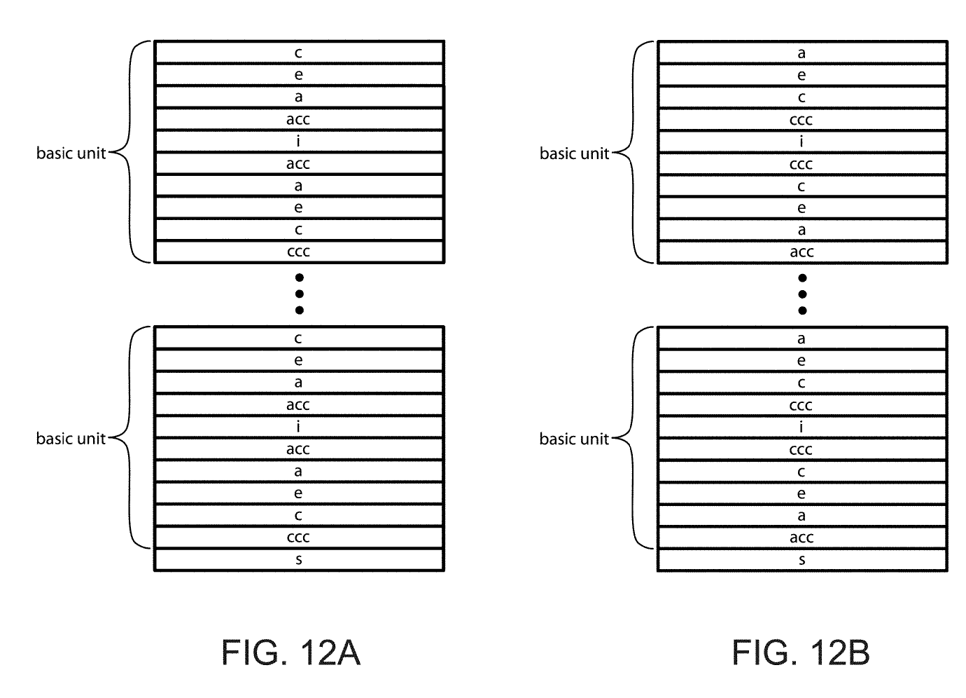

FIGS. 12A and 12B are simplified cross-sectional diagrams of a solid-state thin film battery device according to embodiments of the present invention. As shown, FIG. 12A illustrates a stacked configuration of a basic unit of an electrochemical cell including from top to bottom (in abbreviations): c, e, a, acc, i, acc, a, e, c, and ccc. FIG. 12B shows a similar configuration with the swapping of (a/c) and (acc/ccc).

In an embodiment, the present invention provides a method for the continuous or semi-batch manufacture of a solid-state electrochemical device using a high speed process. This solid-state electrochemical device can include a polymer interlayer and can include multiple repeating stacks of thin film layers forming multiple solid state batteries connected in series, parallel, or any combination thereof. The interlayer can be formed by vaporization methods including flash evaporation, close coupled sublimation, spinning disc evaporation, vapor pressure evaporation, spraying, roller coating, extrusion, and the like. The interlayer can be made from materials including acrylate, acrylic ester, or other polymers and combinations thereof.

In an embodiment, the interlayer can be formed by methods including plasma polymerization, application of electron beam or other application of current, ions, light or other energy source. The energy source can include ion beams, ultraviolet or other wavelength of light, or heaters. These processes can be used to achieve cross-linking, curing, or removal of solvents, plasticizers, stabilizers, or other intermediate elements, including of a hydrocarbon or acrylate, acrylic ester or other polymer. The forming of the polymer interlayer can include cracking or cross-link activation of an acrylate, acrylic ester, or other polymer in a gas phase or a plasma or surface treating of the substrate prior to forming the polymer interlayer.

In an embodiment, the present invention includes a method of manufacturing a solid-state electrochemical device containing a plurality of layers including electrochemically inactive polymeric layers. The method can include executing a computed process to determine a computed and engineered set of dimensions and properties for the layer thickness of each said layer of the plurality of layers, wherein the electrochemically inactive polymeric layers are characterized by thicknesses of less than 5000 Å. These said layers of the plurality of layers can be characterized by characterized by limited diffusion of lithium ions and by reduced stress induced in each layer above said layer at thicknesses of less than 5000 Å.

In an embodiment, the computer process can include: specifying layer thickness, area, and material properties; conducting computer simulations of physics models of the solid-state electrochemical device on a given geometry of the device and boundary conditions for each design space to obtain an energy density of the solid-state electrochemical device; building surrogate models for optimization objectives of the solid-state electrochemical battery cell based on the computer simulations; verifying an accuracy of the surrogate models; repeating the previous steps until the said accuracy of the surrogate models is less than a set criteria; and identifying an optimal design solution for energy density of the solid-state electrochemical battery cell using the said surrogate models.

In an embodiment, the present invention includes a method of the manufacture of a solid-state electrochemical device. The method can include stacking multiple layers of multi-layer battery cells connected in parallel or in series; wherein the stacking of multiple layers of multi-battery cells is characterized by a predetermined manufacturing time and a predetermined throughput. The predetermined manufacturing time can be sufficiently low to achieve an acceptable production throughput.

In an embodiment, the total number of layers deposited in each multi-layer battery cell can be characterized by many features. The total number can be a function of the percentage yield for a predetermined number of cells coupled with a production rate to reduce part cost. The total number can be characterized by a minimization of an aggregate time to completion of a back end assembly of the multi-layer battery cell or by a maximization of an amount of solid-state electrochemical devices by reducing a pumping time. The pumping time can include the time for pumping up and down of a vacuum chamber, and loading up and down of a substrate and other materials.

The method of stacking multiple multi-layers can include digitally controlled robotic arms, automated handlers, grippers, flippers, or other mechanical manipulators. The processes can include physical vapor deposition, thermal evaporation, ion beam assisted e-beam evaporation, ion beam evaporation, induction heating, thermal evaporation, chemical vapor deposition, sputtering, pulsed laser deposition, or atomic layer deposition; wherein the stacking of the multiple layers of multi-battery cells includes depositing an electrochemically inactive polymer layer on a substrate in a vacuum chamber. The method can use a stacking sequence that comprises any variety of battery cells, such as those shown in FIGS. 10AB-12AB, with like sides facing or not, in any number of layers. The stacking sequence can incorporate anode and cathode layers comprising any number of material compositions.

In an embodiment, the method to produce a solid state electrochemical cell device can be enabled by masking, selective etching, automated shielding, micromachining, ablation, or laser processing to produce electrical isolation between certain layers of the multiple layers of multi-battery cells. The certain layers can include between anode and cathode, anode and current collector, cathode and current collector, or any other layers in the stack of the battery cells. Also, the multiple layers of multi-battery cells can include materials that are fed into a production chamber via a source material feeder comprising a conveyor belt, a hopper, an auger, a screw, a wire spool, and a cartridge under a single vacuum.

It is also understood that the examples and embodiments described herein are for illustrative purposes only and that various modifications or changes in light thereof will be suggested to persons skilled in the art and are to be included within the spirit and purview of this application and scope of the appended claims.

1. A method for the continuous or semi-batch manufacture of a solid-state battery device using a high speed process, the method including:
forming multiple repeating stacks of thin film layers overlying a substrate in order to form multiple solid state batteries connected in series or parallel,
wherein forming the multiple repeating stacks of thin film layers includes forming a polymer interlayer having a thickness of 0.5 μm or less.

2. The method of claim 1, wherein the multiple solid state batteries each comprise a thin film layer of cathode material, and the thickness of each of the layers of cathode material in the multiple solid state batteries varies throughout the stack.

3. The method of claim 2, wherein at least one polymer interlayer is associated with the solid state batteries within the stack such that the solid state batteries are of uniform thickness.

4. The method of claim 1, wherein the polymer interlayer is formed by evaporation, close coupled sublimation, spinning disc evaporation, vapor pressure evaporation, spraying, roller coating, or extrusion.

5. The method of claim 1, wherein the polymer interlayer comprises acrylate or acrylic ester.

6. The method of claim 1, wherein the polymer interlayer is formed by plasma polymerization, application of electron beam, application of a heater, or application of current, ion beams, ultraviolet light or other wavelengths of light.

7. The method of claim 1, wherein the forming of the polymer interlayer comprises cross-linking, curing, or removal of solvents, plasticizers, stabilizers, hydrocarbons, acrylate, or acrylic ester.

8. The method of claim 1, wherein forming the polymer interlayer comprises cracking or cross-link activation of an acrylate or acrylic ester in a gas phase.

9. The method of claim 1, wherein forming the polymer interlayer comprises plasma or surface treating of the substrate prior to forming the polymer interlayer.

10. The method of claim 1, wherein stacking of the multiple repeating stacks of multiple solid state batteries is done using digitally controlled mechanical manipulators.

11. The method of claim 1, wherein stacking of the multiple repeating stacks of multiple solid state batteries comprises masking, selective etching, automated shielding, micromachining, ablation, or laser processing to produce electrical isolation between layers.

12. The method of claim 1, wherein stacking multiple repeating stacks of multiple solid state batteries comprises feeding materials into a production chamber via a source material feeder comprising a conveyor belt, a hopper, an auger, a screw, a wire spool, or a cartridge under a single vacuum.
